(19) United States
(12) Patent Application Publication
(10) Pub. No.: US 2003/0018894 A1
(43) Pub. Date: Jan. 23, 2003

(54) System for memorabilia encapsulation and authentication

(76) Inventor: David Hall, Santa Ana, CA (US)

Correspondence Address: STRADLING YOCCA CARLSON & RAUTH, IP Department, Suite 1600, 660 Newport Center Drive, P.O. Box 7680, Newport Beach, CA, 92660-6441, US

(21) Appl. No.: 10/052,332

(22) Filed: Jan. 17, 2002

Related U.S. Application Data
(60) Provisional application No. 60/306,780, filed on Jul. 19, 2001.

(51) Int. Cl. H04L 9/00

(52) U.S. Cl. 713/170

(57) ABSTRACT

A method for authenticating a memorabilia article suitably includes providing a memorabilia article to a recognized authentication service for authenticity processing. The article is associated to a unique personality figure or event,. An autograph of the unique personality figure is inscribed on an identification tag, the autograph being inscribed on the tag in the presence of an agent of the recognized authentication service. The article and autograph are transported to an encapsulation facility, in the care of the authentication service. The memorabilia article and the identification tag are encapsulated in a transparent housing within an encapsulation facility under the supervision of the authentication service; and the housing is permanently sealed along a periphery, such that neither the article nor the tag may be removed therefrom without providing visible indications of tampering on the housing.

### CROSS REFERENCE TO RELATED APPLICATIONS

The present application is related to and takes priority from U.S. Provisional Patent Application Serial No. 60/306,780, filed Jul. 19, 2001, and commonly owned by the assignee of the present application, the entire contents of which are expressly incorporated by reference.

### FIELD OF THE INVENTION

The present invention relates generally to authentication systems and, more particularly, to systems and methods for establishing and maintaining authenticity of memorabilia.

### BACKGROUND OF THE INVENTION

Recently, a substantial interest has developed in acquiring and maintaining memorabilia relating to famous sports figures, events, a the like. The well-known baseball card is an example of such memorabilia and the concept has been extended to include other sports, such as football, hockey, basketball, and the like. In addition to cards honoring the accomplishments of various sports figures, other articles might be established as memorabilia, such as a sliver of the bat with which Babe Ruth's homerun record was broken, a swatch of the glove of a record breaking first baseman, a piece of Bobby Orr's hockey stick, or the signatures of various sports figures themselves.

With the possible exception of an autograph, none of the foregoing articles of memorabilia are self-authenticating, in that is it virtually impossible to determine whether a bat silver is indeed a piece of the famous bat which broke Babe Ruth's homerun record, or is nothing more than a sliver from a bat purchased from a sporting goods store. As the foregoing might suggest, there are very many opportunities available for counterfeiting and misrepresentation in this particular industry, particularly when it is understood that memorabilia articles tend to degrade overtime, such that their value decreases with visible aging.

Various authentication systems are currently practiced in the prior art, particularly with respect to authenticating articles of sports memorabilia. In particular, prior art-type systems generally tend to affix a registration or serial number to the particular article for which authentication is desired. These registration or serial numbers are then assigned to that particular article and maintained in a look-up table, or computerized database for future reference, in a manner quite similar to a warranty card registration procedure.

An additional type of authentication system, exemplified by U.S. Pat. No. 6,303,657 provides an encapsulated biological marker, labeled with an agent that emits selected detectable wavelengths of energy when exposed to a laser or some other excitation media, and associates the labeled marker with a particular memorabilia article, whereby the article can be authenticated as genuine by exposing the label to the elected wavelength of laser light, and detecting the appropriate response. If the label exists, the article is deemed authentic; if not, the entire system (article and authentication indicia) may have been replicated.

Needless to say, although these prior art-type authentication systems exhibit a certain degree of utility in ensuring that the labeled article is genuine, they require that the article be altered in some manner, by either printing either a serial number on the article or affixing a label or other type of designator onto the article which carries either the serial number or a biologic marker. While these forms of alteration might be considered de minimis, they nevertheless alter the pristine condition of the article and might be considered as decreasing its value to some extent.

Accordingly, there is a need in the memorabilia authentication industry for a system and/or method whereby the memorabilia articles might be authenticated without deforming or otherwise altering the articles themselves. Such an authentication system and/or method should be able to provide a rather high degree security for the articles, as well as offer some degree of enhanced value to the memorabilia article itself. In addition to providing an authentication function, such a system and/or method should also be able to provide a certain degree of physical security for the items and prevent, or at least considerably retard, normal degradation with time. For memorabilia that are graded in accordance with their physical condition, such as sports cards, the system and/or method should be able to maintain a “mint” condition issue in that condition for an extended period of time.

### SUMMARY OF THE INVENTION

A method for authenticating a memorabilia article suitably comprises providing a memorabilia article for which authentication is desired, the article associated to a unique personality figure or event, to a recognized authentication service for authenticity processing. An autograph of the unique personality figure is inscribed on an identification tag, the autograph being inscribed on the tag in the presence of an agent of the recognized authentication service. The article and autograph are transported to an encapsulation facility, in the care of the authentication service. The memorabilia article and the identification tag are encapsulated in a transparent housing within an encapsulation facility under the supervision of the authentication service; and the housing is permanently sealed along a periphery, such that neither the article nor the tag may be removed therefrom without providing visible indications of tampering on the housing.

The housing comprises front and rear portions, each constructed of a clear thermoplastic material which does not offer any impairment to visualization of either the memorabilia article or the identification tag. The identification tag further includes front and rear surfaces, both surfaces of the identification tag containing identification and authentication indicia, the front face of the identification tag including text which identifies the issuing entity, the memorabilia article contained within the receptacle and the authentication service.

A portion of the front face of the identification tag includes an area reserved for a grading mark, the grading mark providing an indication of a collectable condition designation of the memorabilia article, the identification tag further including a numerical designator indicating the quality degree within a particular condition designation. The identification tag further includes a serial number, the serial number comprising a unique alpha or alpha numeric sequence which specifically identifies the memorabilia article disposed within the housing.

A marker area is disposed on a portion of the surface of the identification tag and a biological marker is placed within the marker area, the biological marker invisible to the naked eye and only visible under light in specific wavelengths, the presence of the biological marker providing an indication of authenticity of the memorabilia article.

In a further aspect of the invention, a memorabilia article registration database, is established and maintained by the authentication service and the unique serial number is associated to the specific memorabilia article in the database. Encapsulated memorabilia articles are tracked by their unique serial numbers and are identified by verifying the serial number pertains to the corresponding memorabilia item. Authenticity of an article is further verified by a designation of origin on the identification tag and a lack of tamper evidence on their housing.

In an additional aspect of the invention, authenticity is further ensured by performing a scan on the marker area to determine the presence or absence of a biologic marker, the presence of a biological marker giving a further indication of authenticity of an encapsulated memorabilia article.

### DESCRIPTION OF THE DRAWINGS

These and other features, aspects and advantages of the present invention will be more fully understood when considered in connection with the following specification and accompanying drawings, wherein:

FIG. 1, is a simplified, semi-schematic illustration of a piece of exemplary memorabilia, accompanied by an authenticated autograph, and capsulated against damage or alteration in accordance with the present invention;

FIG. 2, is a simplified, semi-schematic diagram illustrating the various components of FIG. 1 prior to encapsulation;

FIG. 3, is an illustration of the grading and authentication data comprising the identification label; and

FIG. 4, is a simplified schematic illustration of a flow diagram exemplifying the authentication and capsulation procedure in accordance with the invention.

### DETAILED DESCRIPTION OF THE INVENTION

Briefly, the present invention can be characterized as a system and method for authenticating memorabilia, utilizing an authentication procedure which relies upon the accuracy and integrity of a Professional Sports Authentication (PSA) service, and subsequently encapsulating both the article of memorabilia and a value-added authentication tag in such a manner that the encapsulated product functions as both the authentication methodology and as a means by which the article may be secured from time degradation.

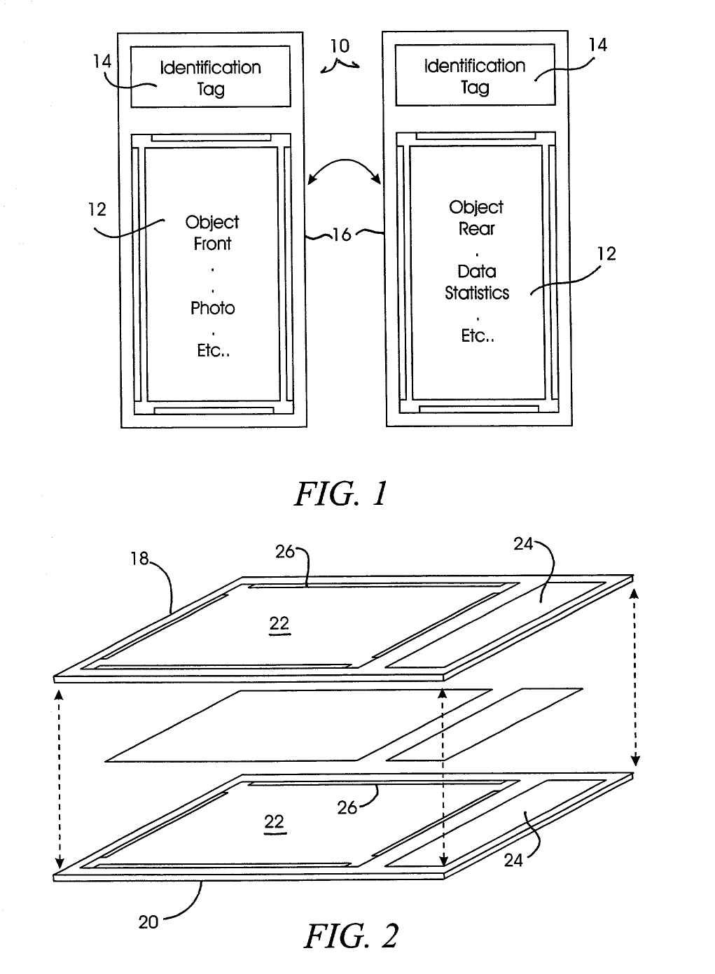

In the exemplary embodiment of FIG. 1 the front and back views of the encapsulated memorabilia product indicated generally at 10, are depicted in simplified, semi-schematic form. The memorabilia product 10 suitably includes an exemplary memorabilia item 12, illustrated for purposes of explanation as a conventional baseball card. Necessarily, the memorabilia item 12 includes a front face and a back face, with the front face (in the exemplary embodiment) depicting a photograph of the particular sports figure to which the item refers. The front face might also include identification indicia, such as the sports figures name, an indication of the particular event to which the card pertains, the card's manufacturer and the like. Further, particularly in the example of baseball cards, the rear face of the item 12 might include explanatory text of the particular event which the card memorializes, such as Nolan Ryan's 7^{th} no-hitter on May 1, 1991, against the Toronto Blue Jays. Alternatively, the item's rear face might include statistics about the particular sports figure memorialized on the item's front face, which might include the sports figure's career highlights, personal profile information and/or recent performance statistics.

Although the memorabilia product 10 is discussed as including a memorabilia item 12 such as a baseball card, it should be understood that the memorabilia product 10 could include any sort of famous or other wise collectable article. Such articles might suitably include rare coins, rare stamps, articles of clothing, pieces of bats, balls, gloves, sticks or any other physical item which is associated with a particular sports figure, note-worthy event, or might otherwise be considered as a collectable.

The memorabilia item 12 is further associated with an identification tag 14 which functions as a means of presenting information about the item 12, as well as authenticating the item and containing information about the authentication service (such as PSA) and an identification indicia which can be referenced by subsequent purchasers to ensure the authenticity of memorabilia item 12, as will be described in greater detail below.

In a particular embodiment of the invention, the identification tag 14 includes a front face and a back face, with the front face particularly including a signature or autograph of the particular individual memorialized in the memorabilia item 12. In this manner, the identification tag 14 might be considered a value-add component to the memorabilia item 12, by virtue of a personalized connection between the identification tag 14 and the memorabilia item 12.

Both the memorabilia item 12 and the identification tag 14 are contained within a housing 16 which secures both the item 12 and the tag 14 against damage, degradation and unauthorized alternation. Preferably, the housing 16 is constructed of a clear thermoplastic material which does not offer any impairment to visualization of either the item 12 or tag 14. A clear, colorless polycarbonite plastic is a suitable material from which the housing 16 might be constructed. In this regard, and in connection with the embodiment of FIG. 2, the housing 16 is provided in two portions, a front portion 18 and a mirror-image rear portion 20, each of which are molded so as to mate together along their peripheral edges. Each of the housing portions include a pair of recesses, deposed on their inside surfaces, a first item recessed 22 and a second label recessed 24. As implied by their names, the item and label recesses are shallow depressions, formed in the inside surfaces of the housing 16, that function to retain and secure a memorabilia item 12 and identification tag 14 in designated locations, after the front and rear portions of the housing 16 are brought together and sealed.

In the context of a baseball card, the item recesses 22 might be provided with peripheral ridges 26 which define a rectangular area into which an object, having the dimensions of a sports memorabilia card, would be inserted. The peripheral ridges 26 would then function to retain the card against lateral movement even when the memorabilia product is manipulated and/or shaken. Further, the peripheral ridges 26 are molded with a thickness dimension slightly greater than the thickness dimension of a conventional sports memorabilia card. As the front and rear portions of the housing brought into contact with one another, the item recesses 22 and peripheral rails 26 define a volume within which the item is enclosed, without either housing portion contacting the item or otherwise applying pressure to item so as to deform or degrade it.

Returning to the exemplary embodiment of FIG. 2, each of the face portions and back portions, 18 and 20, respectively, of the housing 16 include corresponding mating surfaces, disposed about the juxtaposed facing portions of their respective peripheral edges. When the face and back portions are brought into proximity with one another, their respective mating portions come into contact so as to define a peripheral seal. The peripheral seal is made by either sonic welding the two halves of the housing together, or by applying an adhesive or glue to the mating portions which fix the two halves of the housing together. Bonding the housing portions together, after the item 12 identification tag 14 have been disposed within, is an important feature of the present invention, since it ensures the security of the item as well as provides for an additional means of promoting the item's authenticity. Regardless of how the two housing halves are affixed or bonded together, the bond is such that it might be considered permanent, in that any attempt to open the housing 16 and remove the items contained therein, would result in the housing's substantial destruction.

For purposes of this specification, substantial destruction is taken to mean that the housing cannot be opened, such that any of the articles inside are removable, without an immediate and permanent visual indication that evidences that the housing has been tampered with or damaged.

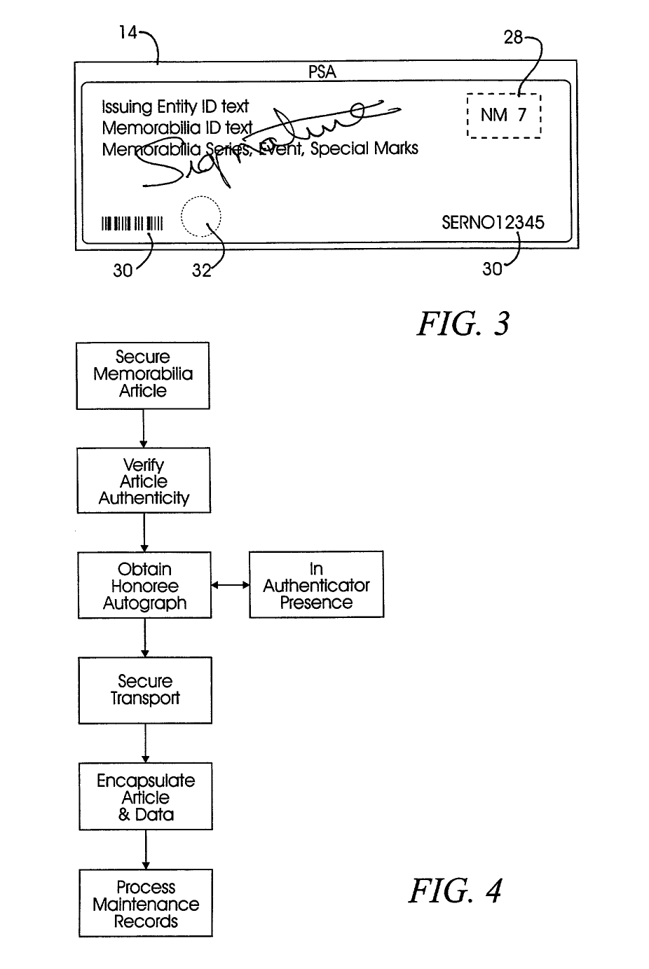

Turning now to the exemplary embodiment of FIG. 3, an identification label or tag 14 is also disposed within a corresponding recess or receptacle 24 within the housing 16. The identification label or tag 14 suitably comprises a front surface and a back surface with both surfaces containing various forms of identification and authentication indicia. In the exemplary embodiment of FIG. 3, the front face of the identification label or tag 14 suitably includes text which identifies the issuing entity, as well as text which identifies the article of memorabilia contained within the item receptacle 22 of the housing. Such text might identify a baseball card, for example, as being a “1991 Stadium Club” issue of a Nolan Ryan commemorative card honoring his 7^{th} no hitter.

A suitable portion of the front face of the tag might include an area reserved for a grading mark 28 which might identify the card as “mint”, “near mint”, or the like, and include an numerical designator indicating the quality degree within a particular condition designation. Thus, in the exemplary embodiment of FIG. 3, the illustrative baseball card is indicated as being NM 7, indicating “near mint” with a quality degree of 7. Such grading indicia are well understood by those skill in the art, and need not be discussed further herein. It is sufficient that the identification label or tag 14 include some indication of the condition of the piece memorabilia contained within the housing, or at least its condition at the time the memorabilia article was encapsulated therein.

A serial number, indicated generally at 30, is also included in the data provided on the identification tag 14. The serial number is a unique alpha or alpha numeric sequence which specifically identifies that particular piece of memorabilia which is contained within the housing. When a purchaser acquires the encapsulated memorabilia item, they are able to register this serial number with an authentication service, in a manner much like registering the warranty with the manufacture of an electronic appliance, for example. The serial number 30 might also be reproduced as a bar code, or in any other machine-readable form, so long as the serial number is an index which is unique to that particular piece of memorabilia.

Additionally, and in accordance with the invention, the identification tag might include a particular area 32 in which a biological marker might be disposed that would further promote authenticity of the memorabilia product 10. A biologic marker might be such as is described in U.S. Pat. No. 6,030,657, and which indicates its presence only under application of light having a particular wavelength or frequency range. Necessarily, the biologic marker is invisible to the unaided human eye and only exhibits its presence when it is affirmatively searched for. In this manner, the authentication system is proof against attempts at counterfeiting the entire memorabilia product i.e, a counterfeit memorabilia item contained within a counterfeit housing. Even where the product of the present invention might be counterfeited in its entirety, the absence of a biologic marker in its designated position on the identification tag 14, would indicate that the article is either not authentic, or was purchased from an entity not having access to the authentication systems and methods of the present invention.

Suitably, the identification tag 14 is manufactured from a material which supports conventional ink printing or writing. As will be described in greater detail below, this is to allow a person with whom the memorabilia item is associated to autograph the identification tag, so as to more personally associate themselves with the memorabilia item. Indeed, and as described in connection with the exemplary flow chart of FIG. 4, generation of the memorabilia product 10 would typically involve having a spots figure or some other note worthy person, autograph a number of identification tags (or alternatively autograph the memorabilia article itself) in the presence of an employee or agent of an authentication service, such as a Professional Sports Authenticator (PSA). The autographed memorabilia components are then securely transported to an encapsulation facility, where each of the component parts are disposed within individual housings, whose edges are then permanently sealed together.

It should be mentioned that although the foregoing description has set forth the component parts of the product as comprising a memorabilia item and an identification tag, the identification tag need not support the autograph, or indeed, need not even be present. Autographs might be made across the memorabilia item itself, and to the extent that the memorabilia item is capable of providing its own unique statistics and registration number indicia, the memorabilia item itself might provide an adequate substitute for an identification tag. All that is required is that the memorabilia product (10 of FIG. 1) have a unique serial or registration indicia, such that it can be identified from amongst other, similar articles, and that it be encapsulated again damage or tampering, such that its value is retained and assured.

It will now be understood how principles of the present invention can be applied to other forms of collectable items, such as rare coins, stamps, and the like. In the case of coins, the housing may of course be provided in a substantially smaller form factor, with its internal recesses being circular (cylindrical) instead of rectangular, due to the nature of the item being enclosed. Again, in the case of housings for coins, the housing might be preferably hermetically sealed in order to keep the surface of the coin from the elements which might otherwise discolor or blemish a mint condition surface.

Although the foregoing specification has described the invention in terms of the exemplary embodiments illustrated in the figures, it will be understood by one having skill in the art that the authentication system and methods of the present invention may be modified in various ways without departing from the scope and spirit of the invention. For example, the housing need not be constructed of a clear, colorless polycarbonate plastic, but might be constructed from any other material that does not impair the visual impression of the memorabilia item. Similarly, the housing might be assembled in a manner that does not require sonic welding or gluing, so long as the housing exhibits an integrity, such that it can not be memorabilia item. Similarly, the housing might be assembled in a manner that does not require sonic welding or gluing, so long as the housing exhibits an integrity, such that it can not be opened or disturbed without leaving permanent visual evidence of tampering or damage. Accordingly, the invention is not limited to the particular embodiments described above. Rather, the invention is intended to cover all modifications and changes that fall within the broad scope of the appended claims.

1. An authenticated memorabilia system, the system comprising:
a housing, the housing having front and rear portions, the front and rear portions including mirror-image indentations, the indentations defining receptacles when the housing portions are mated together;
a memorabilia article disposed in first one of the receptacles;
an identification tag disposed in a second one of the receptacles, the identification tag including an authenticated autograph of a unique individual associated with the memorabilia article; and
wherein the front and rear housing portions are constructed of a substantially transparent material such that a front and rear surface of the memorabilia article and a front and rear surface of the identification tag are visible through the front and rear housing portions.

2. The memorabilia system according to claim 1, wherein the housing portions are constructed of a clear thermoplastic material which does not offer any impairment to visualization of either the memorabilia article or the identification tag.

3. The memorabilia system according to claim 2, both surfaces of the identification tag containing identification and authentication indicia, the front face of the identification tag including text which identifies the issuing entity and text identifying the memorabilia article contained within the receptacle.

4. The memorabilia system according to claim 3, wherein a portion of the front face of the identification tag includes an area reserved for a grading mark, the grading mark providing an indication of a collectable condition designation of the memorabilia article, the identification tag further including a numerical designator indicating the quality degree within a particular condition designation.

5. The memorabilia system according to claim 4, wherein the identification tag further includes a serial number, the serial number comprising a unique alpha or alpha numeric sequence which specifically identifies the memorabilia article disposed within the housing.

6. The memorabilia system according to claim 5, the identification tag further including:
a marker area; and
a biological marker disposed within the marker area, the biological marker invisible to the naked eye and only visible under light in specific wavelengths, the presence of the biological marker providing an indication of authenticity of the memorabilia article.

7. The memorabilia system according to claim 5, further comprising:
an authentication service;
a memorabilia article registration database, maintained by the authentication service; and
wherein the unique serial number is associated to the specific memorabilia article in the database.

8. A method for authenticating a memorabilia article, the method comprising:
providing a memorabilia article, the article associated to a unique personality figure;
inscribing an autograph of the unique personality figure on an identification tag, the autograph being inscribed on the tag in the presence of an agent of a recognized authentication service;
encapsulating the memorabilia article and the identification tag in a housing within an encapsulation facility under the supervision of the authentication service; and
permanently sealing the housing along a periphery, such that neither the article nor the tag may be removed therefrom without providing visible indications of tampering on the housing.

9. The method according to claim 8, wherein the housing comprises front and rear portions, each constructed of a clear thermoplastic material which does not offer any impairment to visualization of either the memorabilia article or the identification tag.

10. The method according to claim 9, the identification tag further including front and rear surfaces, both surfaces of the identification tag containing identification and authentication indicia, the front face of the identification tag including text which identifies the issuing entity, the memorabilia article contained within the receptacle and the authentication service.

11. The method according to claim 10, wherein a portion of the front face of the identification tag includes an area reserved for a grading mark, the grading mark providing an indication of a collectable condition designation of the memorabilia article, the identification tag further including a numerical designator indicating the quality degree within a particular condition designation.

12. The method according to claim 11, wherein the identification tag further includes a serial number, the serial number comprising a unique alpha or alpha numeric sequence which specifically identifies the memorabilia article disposed within the housing.

13. The method according to claim 12, further comprising:
providing a marker area on a surface of the identification tag; and
disposing a biological marker within the marker area, the biological marker invisible to the naked eye and only visible under light in specific wavelengths, the presence of the biological marker providing an indication of authenticity of the memorabilia article.

14. The method according to claim 13, further comprising:
providing a memorabilia article registration database, maintained by the authentication service; and
wherein the unique serial number is associated to the specific memorabilia article in the database.

15. The method according to claim 14, further comprising:
tracking and identifying an encapsulated memorabilia article by its unique serial number;
verifying the serial number pertains to the corresponding memorabilia item; and
verifying the authenticity of an article by a designation of origin and a lack of tamper evidence on their housing.

16. The method according to claim 15, further comprising the step of performing a scan on the marker area to determine the presence or absence of a biologic marker, the presence of a biological marker giving a further indication of authenticity of an encapsulated memorabilia article.
